(19) United States
(12) Patent Application Publication
(10) Pub. No.: US 2021/0088629 A1
(43) Pub. Date: Mar. 25, 2021

(54) DETECTING AN UNMANNED AERIAL VEHICLE USING PASSIVE RADAR

(71) Applicant: Raytheon Company, Waltham, MA (US)

(72) Inventors: Edward M. Jackson, Long Beach, CA (US); Phuoc T. Ho, Westminster, CO (US); Hooman Kazemi, Thousand Oaks, CA (US)

(73) Assignee: Raytheon Company, Waltham, MA (US)

(21) Appl. No.: 17/025,424

(22) Filed: Sep. 18, 2020

Related U.S. Application Data
(60) Provisional application No. 62/905,618, filed on Sep. 25, 2019.

(51) Int. Cl. G01S 7/41; G01S 13/00

(52) U.S. Cl. CPC G01S 7/415; G01S 7/418; G01S 13/003

(57) ABSTRACT

In one aspect, a method includes receiving signals directly or indirectly from a transmitter. The received signals include a target signal, a clutter signal and a reference signal. The method also includes filtering the clutter signal from the received signals, processing the filtered radar data to obtain range and Doppler data, detecting and tracking a target from the range and Doppler data and classifying the target.

### CROSS-REFERENCE TO RELATED APPLICATIONS

This application claims the benefit of U.S. Provisional Application No. 62/905,618 filed Sep. 25, 2019 under 35 U.S.C. § 119(e) which application is hereby incorporated herein by reference in its entirety.

### BACKGROUND

Prior passive radar systems can perform real-time tracking of large objects such as intercontinental missiles and airplanes. However, the low frequency passive radar systems are ineffective in detecting and tracking small objects such as drones in urban environments where line of site of transmitter signals are disrupted by clutter such as, for example, buildings and/or multipath signals are formed.

### SUMMARY

In one aspect, a method includes receiving signals directly or indirectly from a transmitter. The received signals include a target signal, a clutter signal and a reference signal. The method also includes filtering the clutter signal from the received signals, processing the filtered radar data to obtain range and Doppler data, detecting and tracking a target from the range and Doppler data and classifying the target.

In another aspect, a receiver includes a processor and a non-transitory machine-readable medium that stores executable instructions. The instructions cause the processor to receive signals directly or indirectly from a transmitter. The received signals include a target signal, a clutter signal and a reference signal. The instructions further include instructions causing the processor to filter the clutter signal from the received signals, process the filtered radar data to obtain range and Doppler data, detect and track a target from the range and Doppler data and classify the target.

In a further aspect, an apparatus to detect a target includes electronic circuitry to receive signals directly or indirectly from a transmitter. The received signals include a target signal, a clutter signal and a reference signal. The apparatus also includes circuitry to filter the clutter signal from the received signals, process the filtered radar data to obtain range and Doppler data, detect and track a target from the range and Doppler data and classify the target.

One or more of the aspects above may include one or more of the following features. Receiving the signals directly or indirectly from the transmitter may include receiving the signals directly or indirectly from a transmitter transmitting a signal greater than 3 GHz. Classifying the target may include classifying the target as an unmanned aerial vehicle. Detecting and tracking the target from the range and Doppler data may include detecting rotating blades of an unmanned aerial vehicle. The clutter signal may be reflected from at least one of a building, a tower or a structure located in an urban environment. Receiving the signals directly or indirectly from the transmitter may include receiving the signals directly or indirectly from the transmitter using at least two receivers at two separate locations.

### BRIEF DESCRIPTION OF THE DRAWINGS

FIG. 1A is a block diagram of an example of a passive radar environment with a receiver system.

FIG. 1B is a block diagram of another example of the passive radar environment with an example of a receiver system having one receiver.

FIG. 1C is a block diagram of further example of the passive radar environment with another example of the radar system having two receivers.

FIG. 2 is a flowchart of an example of a process to detect, track and classify a target using the receiver system.

FIG. 3 is a block diagram of an example of the receiver system on which the process of FIG. 2 may be implemented.

### DETAILED DESCRIPTION

Described herein are techniques using passive radar to detect, track and classify a target such as a moving object, for example. In one example, the moving object may be an unmanned aerial vehicle or a person. In one particular example, the techniques described herein may be used in an urban environment. The techniques described herein compensate for the shortcomings in detecting a small object in an urban setting by using signals-of-opportunity from higher frequency signals (e.g., 5G cellular signals) and use adaptive clutter cancellation to detect and track small airborne drones.

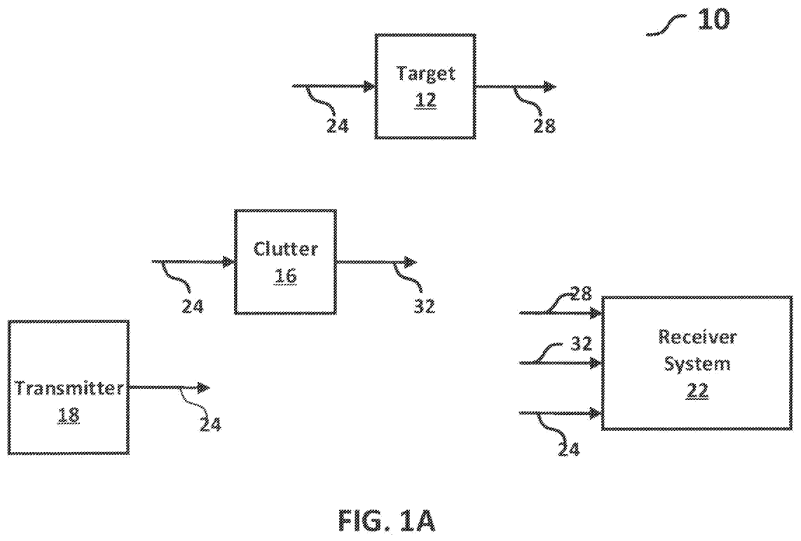

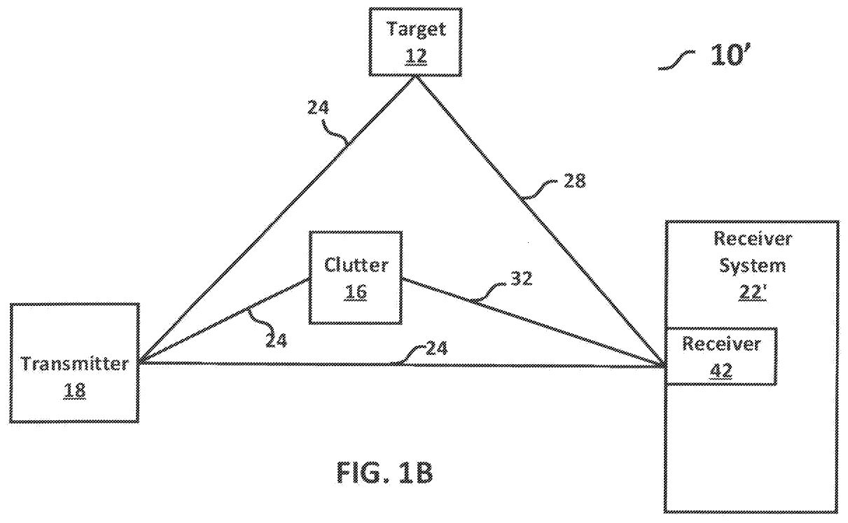

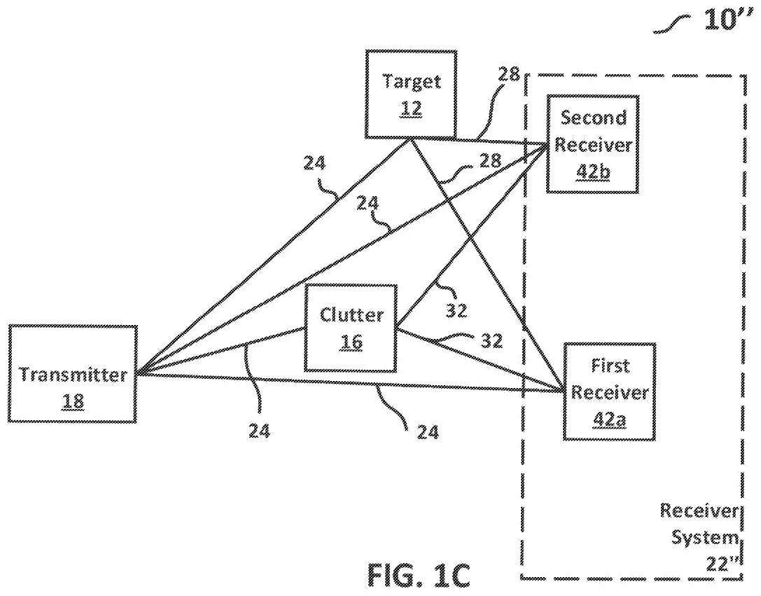

Referring to FIG. 1A, a passive radar environment 10 includes a target 12, a transmitter 18, clutter 16 and a receiver system 22. The term passive radar as used herein means that the receiver system 22 is independent of the transmitter 18 and therefore does not control the transmitter 18 nor is the receiver system 22 co-located with the transmitter 18. In one example, the passive radar environment 10 is located in an urban setting. In some examples, the clutter 16 includes buildings, towers and/or other structures located in an urban environment. In one example, the target 12 is an unmanned aerial vehicle such as, for example, a drone. In another example, the target 12 is a person.

The transmitter 18 transmits a transmitter signal 24 which is received by the target 12, the clutter 16 and the receiver system 22. The receiver system 22 receives the transmitter signal 24 directly from the transmitter 18. As used herein the transmitter signal 24 is also called a reference signal.

The receiver system 22 also receives indirect signals from the transmitter 18. For example, the receiver system 22 receives a target signal 28 which is the transmitter signal 24 reflected from the target 12 and receives a clutter signal 32 which is the transmitter signal 24 reflected from the clutter 16.

The transmitter 18 provides signals greater than 3 GHz. In one example, the transmitter is part of a 5G cellular network. In one example, the receiver system 22 exploits 5G base stations as signals of opportunity. The frequencies used by the 5G network (e.g., signal greater than 3 GHz) improve range resolution and detection against small targets.

In one example, the receiver system 22 may be disposed on a moving platform or the receiver system 22 may be disposed in a stationary structure such as a ground station.

Referring to FIG. 1B, another example of the passive radar environment 10 is a passive radar environment 10′ that includes a receiver system 22′, which is an example of the receiver system 22. The receiver system 22′ includes one receiver, a receiver 42.

In one example, the transmitter 18 transmits the transmitter signal 24 that is reflected off the target 12 to form the target signal 28 that is received by the receiver 42 of the receiver system 22. In another example, the transmitter 18 transmits the transmitter signal 24 that is reflected off the clutter 16 to form the clutter signal 32 that is received by the receiver 42 of the receiver system 22. In a still further example, the transmitter 18 transmits the transmitter signal 24 that is received directly by the receiver 42 of the receiver system 22.

Referring to FIG. 1C, while FIG. 1B shows a single receiver 42 at a single location, the receiver system 22 may include multiple receivers at multiple locations. For example, a passive radar environment 10′ includes a receiver system 22″ that includes a first receiver 42a located at a first location and a second receiver 42b located at a second location. Each receiver 42a, 42b receives the transmitter signal 24, the target signal 28 and the clutter signal 32. In other examples (not shown), one of the receivers 42a, 42b may receive at least one of the transmitter signal 24, the target signal 28 or the clutter signal 32.

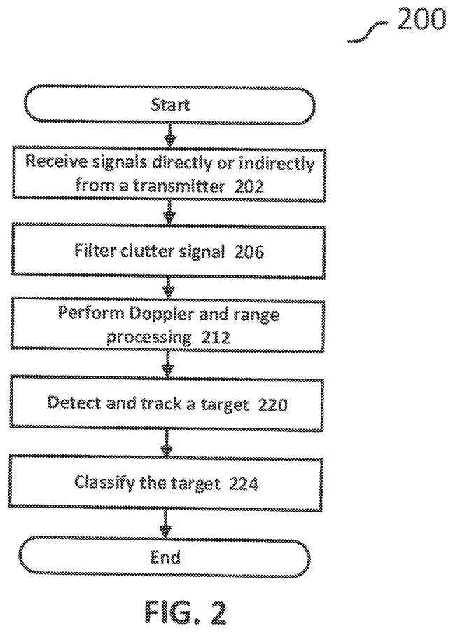

Referring to FIG. 2, an example of a process to detect, track and classify an object is a process 200. The process 200 may be performed by the receiver system 22 (FIG. 1A).

Process 200 receives signals directly or indirectly from the transmitter (202). For example, the receiver system 22 receives the transmitter signal 24, the target signal 28 and the clutter signal 32 (FIG. 1A) in a combined signal. In one example, the transmitter signal 24 (or reference signal) is determined using adaptive beamforming. In one example, the receiver system 22 determines an in-phase (I) and quadrature (Q) of the reference signal 24 and in-phase (I) and quadrature (Q) of the indirect signals or surveillance signals that includes the clutter signal 32 and the target signal 28. The combined signal (which contains target signal 28, the clutter signal 32, and the transmitter signal 24 (or reference signal)) is received with both time delay and Doppler shift that is different from the reference signal 24.

Process 200 filters the clutter signal (206). For example, the receiver system 22 filters the clutter signal 32 to reduce or remove the clutter signal 32 (FIG. 1A). In one example, an adaptive clutter cancellation process is used to remove urban clutter from the received signals. The adaptive clutter cancellation process may operate at lower update rates to reduce multipath and clutter signals. In one example, the reference signal 24 is used to filter the clutter signal 32. After filtering the clutter signal 32, the in-phase (I) and quadrature (Q) of the target signal 28 remains.

Process 200 performs Doppler and range processing (212). For example, the receiver system 22 performs Doppler and range processing (FIG. 1A) on the in-phase (I) and quadrature (Q) of the target signal remaining after performing processing block 206.

For target detection, the reference signal 24 and clutter signal 32 are nulled from the received signal (which includes the transmitter signal 24, the target signal 28, and the clutter signal 32) so that a residual signal is comprised mostly of the target signal 28. The target's range and doppler can be estimated from the range doppler map, which are computed by the cross correlation of the residual signal with the reference signal 24 followed by Fast Fourier Transform.

Process 200 detects and tracks a target (220). For example, the receiver system 22 detects and tracks a target 12 (FIG. 1A) from the range and Doppler data determined in processing block 212. In one example, the receiver system 22 can detect and track the high frequency rotation of the rotary blades of an unmanned aerial vehicle. The range-Doppler response of a target with detectable rotary blades contain attributes that are different from other reflected signatures such as from birds, rain, snow, and so forth.

Process 200 classifies the target (224). For example, the receiver system 22 classifies the target 12 (FIG. 1A). The high frequency rotation detected on a small object (e.g., less than 24 inches) would be indicative of the rotary blades of an unmanned aerial vehicle and thus the target 12 would be classified as an unmanned aerial vehicle and distinguished from the slower flapping of wings on birds, for example. In one example, a machine learning classifier is used to identify targets. The machine learning classifier can discriminate between slowly moving and closely spaced targets.

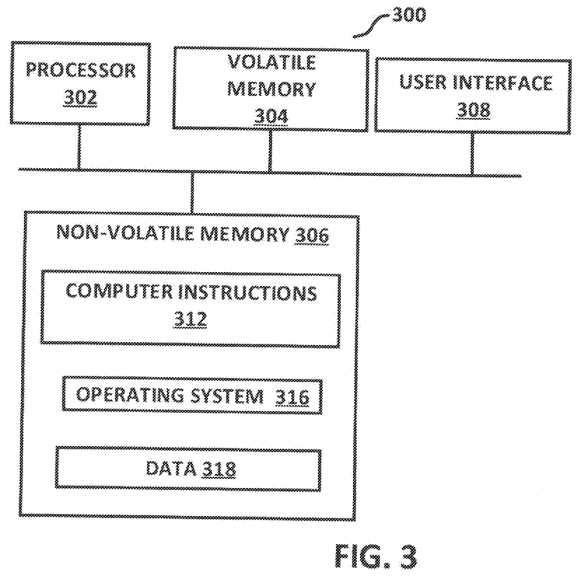

Referring to FIG. 3, an example of the receiver system 22 (FIG. 1A) is a receiver system 300. The receiver system 300 includes a processor 302, a volatile memory 304, a non-volatile memory 306 (e.g., hard disk) and the user interface (UI) 308 (e.g., a graphical user interface, a mouse, a keyboard, a display, touch screen and so forth). The non-volatile memory 306 stores computer instructions 312, an operating system 316 and data 318. In one example, the computer instructions 312 are executed by the processor 302 out of volatile memory 304 to perform all or part of the processes described herein (e.g., process 200).

The processes described herein (e.g., process 200) are not limited to use with the hardware and software of FIG. 3; they may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each includes a processor, a non-transitory machine-readable medium or other article of manufacture that is readable by the processor (including volatile and non-volatile memory and/or storage elements), at least one input device, and one or more output devices. Program code may be applied to data entered using an input device to perform any of the processes described herein and to generate output information.

The system may be implemented, at least in part, via a computer program product, (e.g., in a non-transitory machine-readable storage medium), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, volatile memory, magnetic diskette and so forth but does not include a transitory signal per se.

The processes described herein are not limited to the specific examples described. For example, the process 200 is not limited to the specific processing order of FIG. 2, respectively. Rather, any of the processing blocks of FIG. 2 may be re-ordered, combined or removed, performed in parallel or in serial, as necessary, to achieve the results set forth above.

The processing blocks (for example, in the process 200) associated with implementing the system may be performed by one or more programmable processors executing one or more computer programs to perform the functions of the system. All or part of the system may be implemented as, special purpose logic circuitry (e.g., an FPGA (field-programmable gate array) and/or an ASIC (application-specific integrated circuit)). All or part of the system may be implemented using electronic hardware circuitry that include electronic devices such as, for example, at least one of a processor, a memory, programmable logic devices or logic gates.

Elements of different embodiments described herein may be combined to form other embodiments not specifically set forth above. Other embodiments not specifically described herein are also within the scope of the following claims.

What is claimed is:

1. A method, comprising:
receiving signals directly or indirectly from a transmitter, wherein the received signals comprise a target signal, a clutter signal and a reference signal;
filtering the clutter signal from the received signals;
processing the filtered radar data to obtain range and Doppler data;
detecting and tracking a target from the range and Doppler data; and
classifying the target.

2. The method of claim 1, wherein receiving the signals directly or indirectly from the transmitter comprises receiving the signals directly or indirectly from a transmitter transmitting a signal greater than 3 GHz.

3. The method of claim 1, wherein classifying the target comprises classifying the target as an unmanned aerial vehicle.

4. The method of claim 1, wherein detecting and tracking the target from the range and Doppler data comprises detecting rotating blades of an unmanned aerial vehicle.

5. The method of claim 1, wherein the clutter signal is reflected from at least one of a building, a tower or a structure located in an urban environment.

6. The method of claim 1, wherein receiving the signals directly or indirectly from the transmitter comprises receiving the signals directly or indirectly from the transmitter using at least two receivers at two separate locations.

7. A receiver comprising:
a processor; and
a non-transitory machine-readable medium that stores executable instructions, the instructions causing the processor to:
receive signals directly or indirectly from a transmitter, wherein the received signals comprise a target signal, a clutter signal and a reference signal;
filter the clutter signal from the received signals;
process the filtered radar data to obtain range and Doppler data;
detect and track a target from the range and Doppler data; and
classify the target.

8. The receiver of claim 7, wherein the instructions causing the processor to receive the signals directly or indirectly from the transmitter comprises instructions causing the processor to receive the signals directly or indirectly from a transmitter transmitting a signal greater than 3 GHz.

9. The receiver of claim 7, wherein the instructions causing the processor to classify the target comprises instructions causing the processor to classify the target as an unmanned aerial vehicle.

10. The receiver of claim 7, wherein the instructions causing the processor to detect and track the target from the range and Doppler data comprises instructions causing the processor to detect rotating blades of an unmanned aerial vehicle.

11. The receiver of claim 7, wherein the clutter signal is reflected from at least one of a building, a tower or a structure located in an urban environment.

12. The receiver of claim 7, wherein the instructions causing the processor to receive the signals directly or indirectly from the transmitter comprises the instructions causing the processor to receive the signals directly or indirectly from the transmitter using at least two receivers at two separate locations.

13. An apparatus to, comprising:
electronic circuitry to:
receive signals directly or indirectly from a transmitter, wherein the received signals comprise a target signal, a clutter signal and a reference signal;
filter the clutter signal from the received signals;
process the filtered radar data to obtain range and Doppler data;
detect and track a target from the range and Doppler data; and
classify the target.

14. The apparatus of claim 13, wherein the circuitry comprises at least one of a processor, a memory, programmable logic or a logic gate.

15. The apparatus of claim 13, wherein the circuitry to receive the signals directly or indirectly from the transmitter comprises circuitry to receive the signals directly or indirectly from a transmitter transmitting a signal greater than 3 GHz.

16. The apparatus of claim 13, wherein the circuitry to classify the target comprises circuitry to classify the target as an unmanned aerial vehicle.

17. The apparatus of claim 13, wherein the circuitry to detect and track the target from the range and Doppler data comprises circuitry to detect rotating blades of an unmanned aerial vehicle.

18. The apparatus of claim 13, wherein the clutter signal is reflected from at least one of a building, a tower or a structure located in an urban environment.

19. The apparatus of claim 13, wherein the circuitry to receive the signals directly or indirectly from the transmitter comprises circuitry to receiving the signals directly or indirectly from the transmitter using at least two receivers at two separate locations.
